(19) United States
(12) Patent Application Publication
(10) Pub. No.: US 2025/0368117 A1
(43) Pub. Date: Dec. 4, 2025

(54) SELF-LOADING ASSEMBLY AND VEHICLE INCLUDING SUCH SELF-LOADING ASSEMBLY

(71) Applicant: Quantum Bodies IP PTY LTD, Wilberforce, NSW (AU)

(72) Inventor: Jason McCallum, Wilberforce, NSW (AU)

(73) Assignee: Quantum Bodies IP PTY LTD, Wilberforce, NSW (AU)

(21) Appl. No.: 18/870,281

(22) PCT Filed: May 29, 2023
(86) PCT No.: PCT/AU2023/050453

§ 371 Date: Nov. 27, 2024

(30) Foreign Application Priority Data
May 29, 2022 (AU) 2022901445

(51) Int. Cl. B60P 1/48; B60P 1/64

(52) U.S. Cl. CPC B60P 1/483; B60P 1/6427

(57) ABSTRACT

A self-loading assembly (10) for a vehicle (12) including a base frame (14) operatively secured to the vehicle (12) and a cargo body (16) operatively adapted to be located on the base frame (14) to be transported by the vehicle (12). The self-loading assembly (10) further includes a loading arm (22) operatively associated with the base frame (14), the loading arm (22) operatively adapted to move relative to the base frame (14) between (i) a transport position in which the cargo body (16) is located on to the base frame (14), and (ii) an offload position wherein the cargo body (16) is offloaded from the base frame (14). The self-loading assembly (10) further includes an actuator assembly (28) operatively adapted to move the loading arm (22) between the transport position and the offload position, the actuator assembly including (i) an arm pivot member (30) on which the loading arm (22) is mounted and about which the loading arm (22) pivots as it moves between the transport position and the offload position, and (ii) a linkage assembly (32) connecting the loading arm (22) with an actuator (34), the linkage assembly (32) adapted to move the loading arm between the transport position and the offload position when the actuator (34) is caused to move between a first position and a second position.

### FIELD

The invention concerns a self-loading assembly. In one non-exclusive aspect the invention concerns a self-loading assembly for loading and offloading a cargo body from a vehicle. In a further aspect the invention concerns a vehicle including a self-loading assembly for loading and off-loading a cargo body from the vehicle.

### BACKGROUND

Tradespersons will attest to the effort and frustration associated with loading and offloading equipment from a utility vehicle necessitated by different tasks to be undertaken and different equipment required to be transported. A tradesperson may for one application require a flat cargo tray (commonly referred to as a “ute tray” in Australia) and in another application a toolbox body accommodating equipment. For recreational purposes, a tradesperson may require the cargo tray to accommodate recreational equipment for the weekend which typically requires the effort of clearing the cargo tray of all work equipment employed and transported during the workweek.

To address this problem many tradespersons have resorted to acquiring multiple utility vehicles each having a cargo tray suitably equipped for a particular activity. Depending on the activity the tradesperson is to engage in, they can elect the appropriate vehicle for the task at hand. The problem with such approach of course is firstly the substantial costs associated with acquiring multiple utility vehicles and then the associated ongoing costs in maintaining multiple vehicles as well as insurance and registration costs.

### OBJECT

It is an object of the present invention to provide a self-loading assembly and a vehicle including the self-loading assembly which address or ameliorate the above drawbacks, or which at least provide useful alternatives.

### SUMMARY

According to a first aspect there is disclosed herein a self-loading assembly for a vehicle, the self-loading assembly including:
a base frame operatively secured to the vehicle;
a cargo body operatively adapted to be located on the base frame to be transported by the vehicle;
a loading arm operatively associated with the base frame, the loading arm operatively adapted to move relative to the base frame between (i) a transport position in which the cargo body is located on the base frame, and (ii) an offload position wherein the cargo body is offloaded from the base frame; and
an actuator assembly operatively adapted to move the loading arm between the transport position and the offload position, the actuator assembly including (i) an arm pivot member on which the loading arm is mounted and about which the loading arm pivots as it moves between the transport position and the offload position, and (ii) a linkage assembly connecting the loading arm with an actuator, the linkage assembly adapted to move the loading arm between the transport position and the offload position when the actuator is caused to move between a first position and a second position.

Preferably the vehicle is a utility vehicle or a light commercial vehicle.

Preferably the linkage assembly includes (i) an arm linkage member coupled to the loading arm, and (ii) a frame linkage member coupled to the base frame at a base end and to the arm linkage member at an arm linkage member end.

Preferably the frame linkage member is pivotally mounted about a frame pivot member coupled to the base frame.

Preferably the frame linkage member defines a recess operatively adapted to receive the arm pivot member therein when the loading arm is located in the offload position.

Preferably the arm linkage member is (i) coupled to the loading arm via a linkage pivot member located at an arm end of the arm linkage member, and (ii) coupled to the actuator via an actuator pivot member at an actuator end of the arm linkage member.

Preferably the frame linkage member is a first frame linkage member and the linkage assembly includes a second frame linkage member opposing the first frame linkage member and laterally spaced apart from the first frame linkage member.

Preferably the actuator includes an actuator rod moveable between a retracted position and an extended position, wherein the actuator is moved from the first position to the second position as the actuator rod is moved from the retracted position to the extended position.

Preferably the loading arm includes a first loading arm member and a transverse second loading arm member, the first loading arm member being mounted to the arm pivot member.

Preferably the first loading arm member defines an actuator space for holding the actuator when the loading arm is located in the transport position.

Preferably the second loading arm member includes a gripping assembly operatively adapted to grip a portion of the cargo body.

Preferably the gripping assembly includes a gripping actuator operatively adapted to locate the gripping assembly in (i) a gripping position for gripping the cargo body, and (ii) a release position to release the cargo body.

Preferably the second loading arm member includes a secondary actuator operatively adapted to move the second loading arm member between a rest position and an active position, wherein movement of the second loading arm member to the active position causes the cargo body to be tilted.

Preferably the base frame includes a frame body and a subframe assembly to move relative to the frame body.

Preferably the base frame includes a frame actuator to effect movement of the subframe assembly.

Aspect of the invention extend to a vehicle including the self-loading assembly of the first aspect.

### BRIEF DESCRIPTION OF THE DRAWINGS

Preferred embodiments of the invention will be described hereinafter, by way of examples only, with reference to the accompany drawings wherein:

FIG. 1 is diagrammatic side view of a first embodiment self-loading assembly for a vehicle wherein a loading arm of the self-loading assembly is located in a transport position;

FIG. 2 is diagrammatic side view of the self-loading assembly of FIG. 1 wherein the loading arm has undergone an amount of pivotal movement;

FIG. 3 is diagrammatic side view of the self-loading assembly of FIG. 1 wherein the loading arm has undergone a further amount of pivotal movement;

FIG. 4 is diagrammatic side view of the self-loading assembly of FIG. 1 wherein the loading arm has been located in an offload position so as to offload a cargo body;

FIG. 5 is side view of the loading arm of the self-loading assembly of FIG. 1;

FIG. 6 is a side view of an actuator assembly of the self-loading assembly of FIG. 1 wherein the loading arm is located in the transport position;

FIG. 7 is a side view of an actuator assembly of the self-loading assembly of FIG. 4 wherein the loading arm is located in the offload position;

FIG. 8 is a diagrammatic top view of a portion of the actuator assembly of FIG. 6;

FIG. 9 is diagrammatic side view of the self-loading assembly of FIG. 1 with the loading arm located in a position wherein a secondary actuator of the loading arm can be caused to move to an active position;

FIG. 10 is diagrammatic side view of the self-loading assembly of FIG. 9 wherein the secondary actuator of the loading arm has been moved to the active position, thereby causing the cargo body to be tilted to offload cargo;

FIG. 11 is a top view of a base frame of the self-loading assembly of FIG. 1;

FIG. 12 is a side view of the base frame of FIG. 11;

FIG. 13 is a diagrammatic side view of a second embodiment self-loading assembly for use with a short wheelbase commercial vehicle wherein a loading arm of the self-loading assembly is located in a transport position;

FIG. 14 is diagrammatic side view of the self-loading assembly of FIG. 13 wherein the loading arm has undergone an amount of pivotal movement though 65 degrees;

FIG. 15 is diagrammatic side view of the self-loading assembly of FIG. 13 wherein the loading arm has undergone an amount of pivotal movement though 65 degrees and a second loading arm member has been moved from a rest position to an active position;

FIGS. 16 to 20 are diagrammatic side views of the self-loading assembly of FIG. 13 depicting the loading arm undergoing pivotal movement;

FIG. 21 is a diagrammatic side view of the self-loading assembly of FIG. 13 wherein the loading arm has been located in an offload position so as to offload a cargo body;

FIG. 22 is a diagrammatic top view illustrating portions of the loading arm and actuator assembly;

FIG. 23 is diagrammatic side view of a third embodiment self-loading assembly for use with a medium wheelbase commercial vehicle wherein a loading arm of the self-loading assembly is located in a transport position;

FIG. 24 is a diagrammatic side view of the self-loading assembly of FIG. 23 wherein the loading arm has been caused to under an amount of pivotal movement;

FIG. 25 is a diagrammatic side view of the self-loading assembly of FIG. 23 wherein the loading arm and an actuating assembly of the locating arm have been displaced relative to a cabin of the medium wheelbase commercial vehicle;

FIGS. 26 to 31 are diagrammatic side views of the self-loading assembly of FIG. 23 depicting the loading arm undergoing pivotal movement;

FIG. 32 is diagrammatic side view of the self-loading assembly of FIG. 23 wherein the loading arm has been located in an offload position so as to offload a cargo body;

FIG. 33 is a diagrammatic side of a base frame and actuator assembly of the self-loading assembly of FIG. 23; and

FIG. 34 is a diagrammatic top view of the base frame and actuator assembly of the self-loading assembly of FIG. 23.

### DESCRIPTION OF PREFERRED EMBODIMENTS

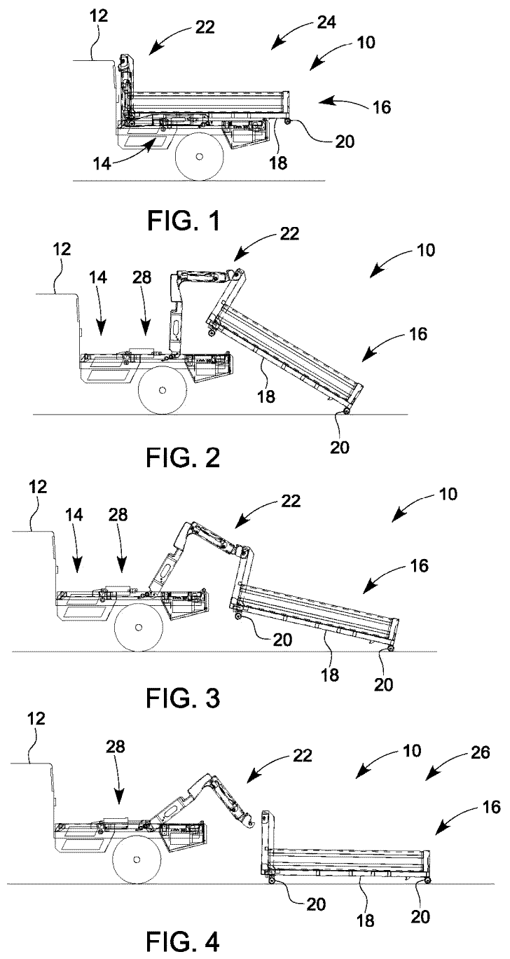

FIGS. 1 to 4 show a first embodiment self-loading assembly, generally indicated with the reference numeral 10, for use with a utility vehicle 12. The self-loading assembly 10 includes a base frame 14 operatively secured to the vehicle 12 and a cargo body 16 operatively adapted to be located on the base frame 14 to be transported by the vehicle 12. The embodiment cargo body 16 comprises a flat tray 18 having a plurality of casters 20 attached thereto to facilitate ease of movement.

The self-loading assembly 10 includes a loading arm 22 operatively associated with the base frame 14. The loading arm 22 is operatively adapted to move relative to the base frame 14 between (i) a transport position 24, shown in FIG. 1, in which the cargo body 16 is located on/supported by the base frame 14, and (ii) an offload position 26, shown in FIG. 4, wherein the cargo body 16 is offloaded from the base frame 14.

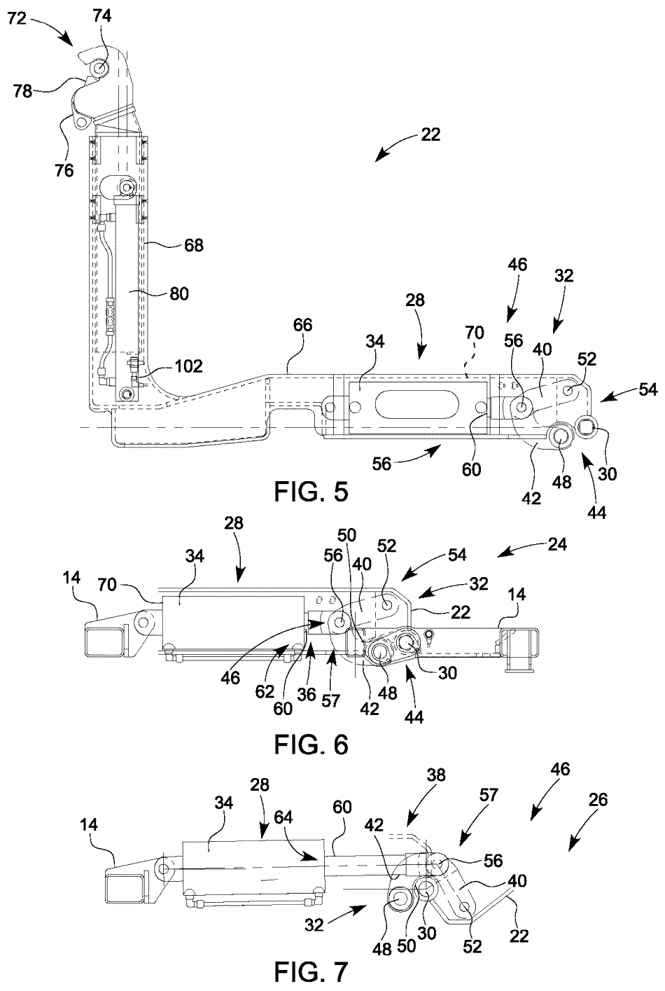

The self-loading assembly 10 also includes an actuator assembly 28 operatively adapted to move the loading arm 22 between the transport position 24 and the offload position 26. Referring also to FIGS. 5 to 7, the actuator assembly 28 includes (i) an arm pivot member 30 on which the loading arm 22 is mounted and about which the loading arm 22 pivots as it moves between the transport position 24 and the offload position 26, and (ii) a linkage assembly 32 connecting the loading arm 22 with an actuator 34. The linkage assembly 32 is adapted to move the loading arm 22 between the transport position 24 and the offload position 26 when the actuator 34 is caused to move between a first position 36, shown in FIG. 6, and a second position 38, shown in FIG. 3. In this embodiment the actuator 34 is provided in the form of a 12V DC electric/hydraulic powerpack that powers a 5″ bore×2″ rod×8″ stroke hydraulic ram.

FIGS. 1 to 4 depict movement of the loading arm 22 to offload the tray 18 from the utility vehicle 12. A different non-illustrated tray can now be connected to the loading arm 22. By moving the loading arm 22 from the offload position 26 to the transport position 24 the new tray can be secured to the utility vehicle 12 for transport.

The linkage assembly 32 includes (i) an arm linkage member 40 coupled to the loading arm 22, and (ii) a frame linkage member 42 coupled to the base frame 14 at a base end 44 and to the arm linkage member 40 at an arm linkage member end 46.

The embodiment frame linkage member 42 is pivotally mounted about a frame pivot member 48 coupled to the base frame 14. The frame linkage member 42 is inwardly curved as shown so as to define a recess 50 operatively adapted to receive/accommodate the arm pivot member 30 therein when the loading arm 22 is located in the offload position 26 shown in FIG. 7. The linkage assembly 32 is adapted to rotate the loading arm 22 through 142.09 degrees thus providing a compact unit suitable for light vehicles. The embodiment actuator assembly 28 obviates the need of a much longer stroke ram, for which there is no room on a utility vehicle, which would normally be required. Furthermore, the design of the actuator assembly 28 reduces the weight of the unit so as to enhance the payload of the cargo body 16, in this embodiment a one-tonne payload.

The arm linkage member 40 is coupled (i) to the loading arm 22 via a linkage pivot member 52 located at an arm end 54 of the arm linkage member 40, and (ii) to the actuator 34 via an actuator pivot member 56 at an actuator end 57 of the arm linkage member 40.

In this embodiment the frame linkage member 42 is a first frame linkage member and the linkage assembly 32 includes a second frame linkage member 58 opposing the first frame linkage member 42 and being laterally spaced apart from the first frame linkage member 42.

The actuator 34 includes an actuator rod 60 moveable between a retracted position 62, shown in FIG. 6, and an extended position 64 shown in FIG. 7 wherein the actuator 34 is moved from the first position 36 to the second position 38 as the actuator rod 60 is moved from retracted position 62 to the extended position 64.

The loading arm 22 includes a first loading arm member 66 and a transverse second loading arm member 68. The first loading arm member 66 is mounted to the arm pivot member 30. The first loading arm member 66 defines an actuator space 70 for holding the actuator 34 when the loading arm 22 is located in the transport position 24. The second loading arm member 68 includes a gripping assembly 72 operatively adapted to grip a portion of the cargo body 74, here in the form of an elongate shaft. The gripping assembly 72 includes a gripping actuator 76 operatively adapted (i) to locate the gripping assembly 72 in a gripping position 77 for gripping the portion of the cargo body 74, and (ii) a non-illustrated release position to release the cargo body 16. In this embodiment a user effecting a pulling motion on the gripping actuator 76 will retract a locking member 78 such that the portion of the cargo body 74 held by the gripping assembly 72 can be released therefrom.

The second loading arm member 68 includes a secondary actuator 80 operatively adapted to move the second loading arm member 68 between a rest position 82, shown in FIG. 9, and an active position 84, shown in FIG. 10. Movement of the second loading arm member 68 to the active position 84 causes the cargo body 16 to be tilted. When the cargo transported on the cargo body 16 is soil, locating the second loading arm member 68 in the active position will assist in offloading the soil. In this embodiment the secondary actuator 80 is an hydraulic extension ram 2″ bore×1¼″ rod×16″ stroke which extends the loading arm by 406.4 mm. This feature allows the cargo body to tilt to a 50-degree angle which is good for tipping and further provides the ability to load and offload different cargo bodies on varying uneven terrains. The secondary actuator 80 is prevented to extend until the loading arm 22 has rotated through 65 degrees. This activation is controlled via electric proximity switches one of which is shown in FIG. 5 and indicated with the reference numeral 102. This feature prevents the cargo body 16 being dragged forward and possibly colliding with the cabin of the utility vehicle 12. Once the loading arm has reached 65 degrees rotation the secondary actuator 80 can extend to a desired length. The reverse will occur on the return of the loading arm 22 to the transport position 24.

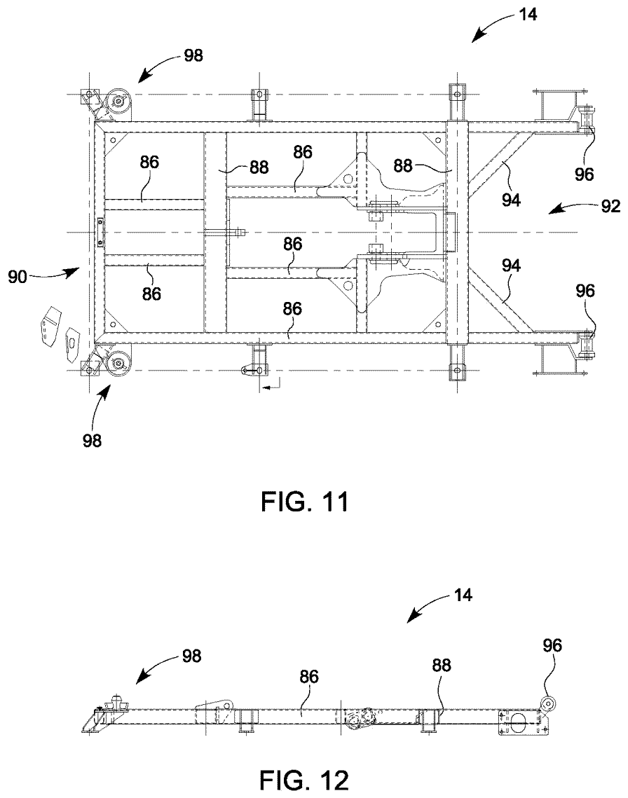

FIGS. 11 and 12 show the base frame 14 as including elongate, laterally spaced apart support members 86 secured by a plurality of transverse cross-members 88. The base frame 14 has a cabin end 90 operatively located towards the cabin of the utility vehicle 12 and an opposing rear end 92. Two brace members 94 are located towards the rear end 92. Further, two rollers 96 are located towards the rear end 92 to guide movement of the cargo body 16 along the base frame 14. The base frame 14 includes two securement formations 98 operatively adapted to cooperate with corresponding non-illustrated formations on the underside of the cargo body 16 to assist in securing the cargo body 16 in position on the base frame 14.

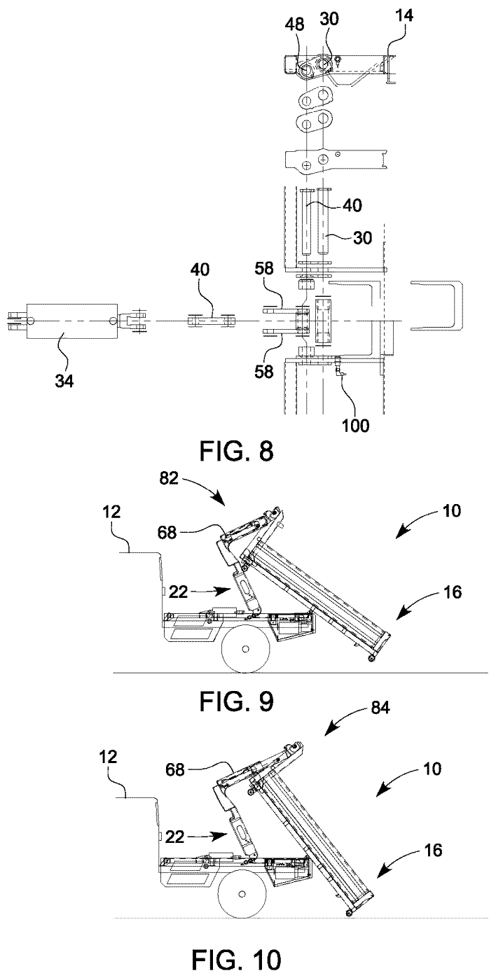

The self-loading assembly 10 includes a non-illustrated electronic control system for controlling actuation of the actuator 34 and the secondary actuator 80. The electronic control system will typically be adapted to be operated by pendant control or to communicate with a remote activation unit via which a user can control activation of the actuators 34, 80. The control system further includes proximity sensors 100, one of which are shown in FIG. 8, to determine when the cargo body 16 is proximate a determined location whereafter the actuator 34 is deactivated.

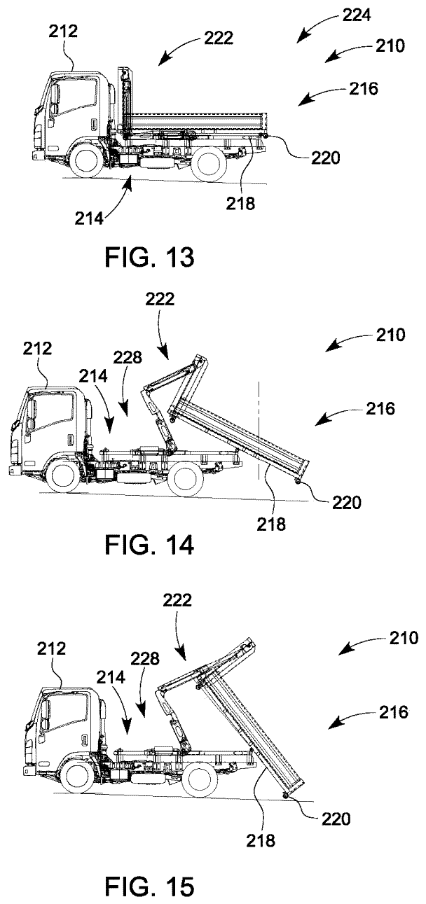

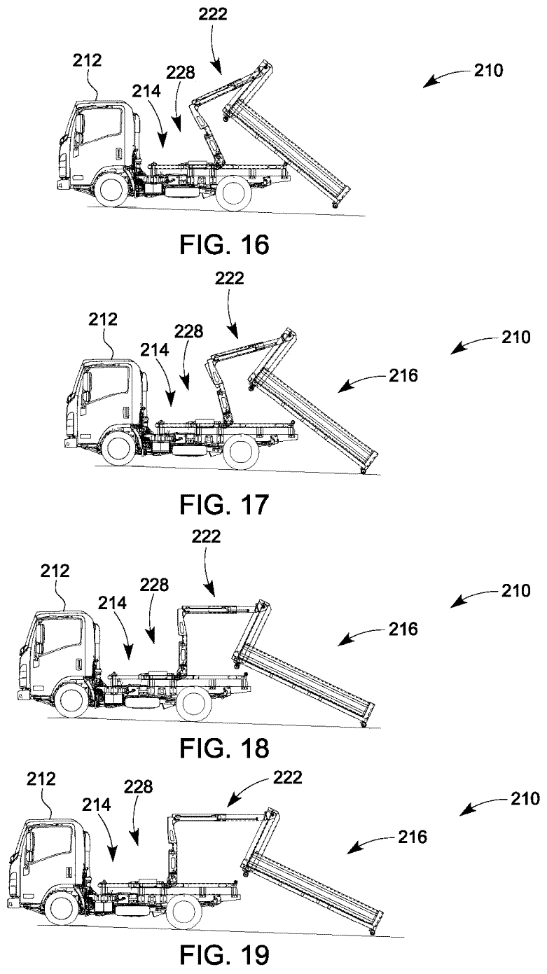

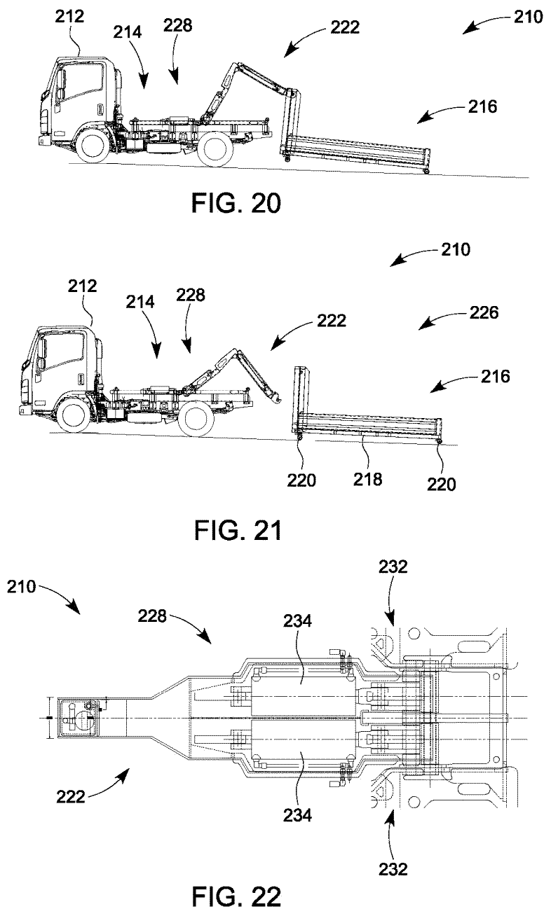

FIGS. 13 to 21 show a second embodiment self-loading assembly, generally indicated with the reference numeral 210, for use with a 2-tonne short wheelbase commercial vehicle 212. The self-loading assembly 210 includes a base frame 214 operatively secured to the vehicle 212 and a cargo body 216 operatively adapted to be located on the base frame 214 to be transported by the vehicle 212. The embodiment cargo body 216 comprises a flat tray 218 having a plurality of casters 220 attached thereto to facilitate ease of movement.

The self-loading assembly 210 includes a loading arm 222 operatively associated with the base frame 214. The loading arm 222 is operatively adapted to move relative to the base frame 214 between (i) a transport position 224, shown in FIG. 13, in which the cargo body 216 is located on/supported by the base frame 214, and (ii) an offload position 226, shown in FIG. 21, wherein the cargo body 216 is offloaded from the base frame 214.

Referring also to FIG. 22, the self-loading assembly 210 also includes an actuator assembly 228 operatively adapted to move the loading arm 222 between the transport position 224 and the offload position 226. The actuator assembly 228 operates on the same principles as the actuator assembly 28. However, the actuator assembly 228 includes two actuators 234 located side-by-side so that the actuator assembly 228 includes (i) two non-illustrated arm pivot members on which the loading arm 222 is mounted and about which the loading arm 222 pivots as it moves between the transport position 224 and the offload position 226, and (ii) two linkage assemblies 232 respectively connecting the loading arm 222 with the two actuators 234. The linkage assemblies 232 are adapted to move the loading arm 222 between the transport position 224 and the offload position 226 when the actuators 234 are caused to move between a non-illustrated first position and second position 238. In this embodiment the actuators 234 are each provided in the form of a 5″ bore×2″ rod×8″ stroke hydraulic ram powered by a non-illustrated power take-off (PTO). It will of course be appreciated the stroke of the actuators could vary. The reason for having two actuators 234 is to enable the actuator assembly 228 to accommodate greater payload to be carried by the cargo body 216, as compared with the cargo body 16 of the utility vehicle 12, and which is to be offloaded by the self-loading assembly 200.

It is pointed out that in the offload position 226 of FIG. 21 the loading arm 222 has rotated through 142.09 degrees. Referring to FIG. 14 the loading arm 222 has been rotated though 65 degrees. In FIG. 15 the loading arm 222 has been extended while held at the 65-degree angle. At this angle the cargo body 216 is tipped at 52 degrees.

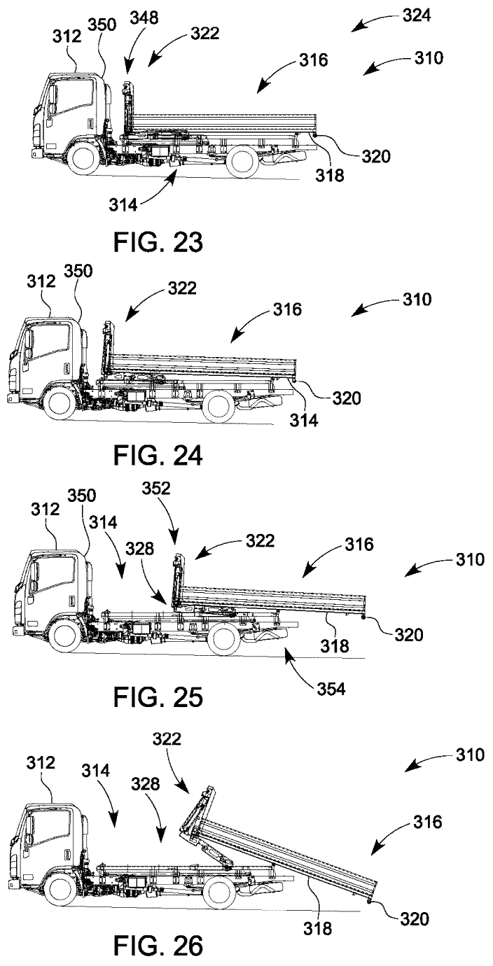

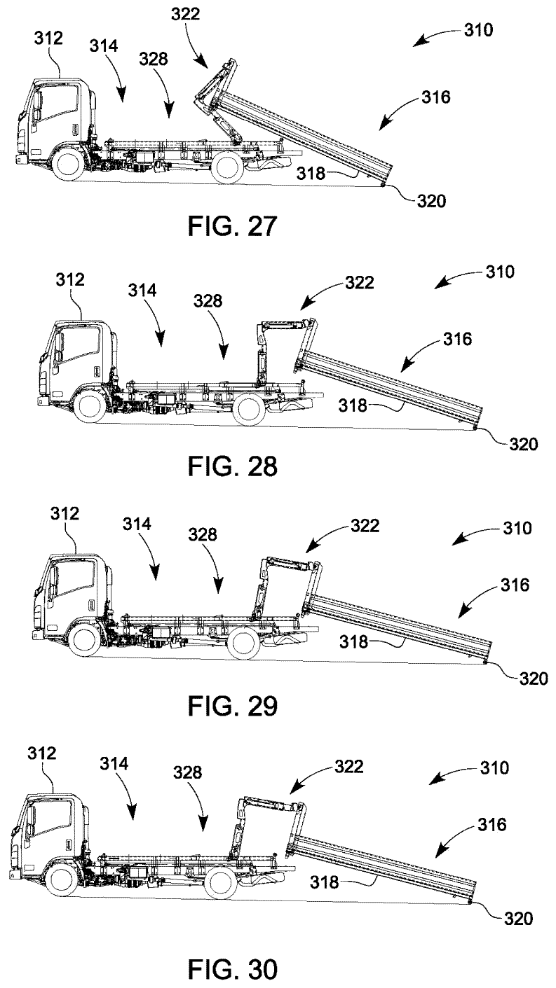

FIGS. 23 to 32 show a third embodiment self-loading assembly, generally indicated with the reference numeral 310, for use with a 2-tonne medium wheelbase commercial vehicle 312. The self-loading assembly 310 includes a base frame 314 operatively secured to the vehicle 312 and a cargo body 316 operatively adapted to be located on the base frame 314 to be transported by the vehicle 312. The embodiment cargo body 316 comprises a flat tray 318 having a plurality of casters 320 attached thereto to facilitate ease of movement.

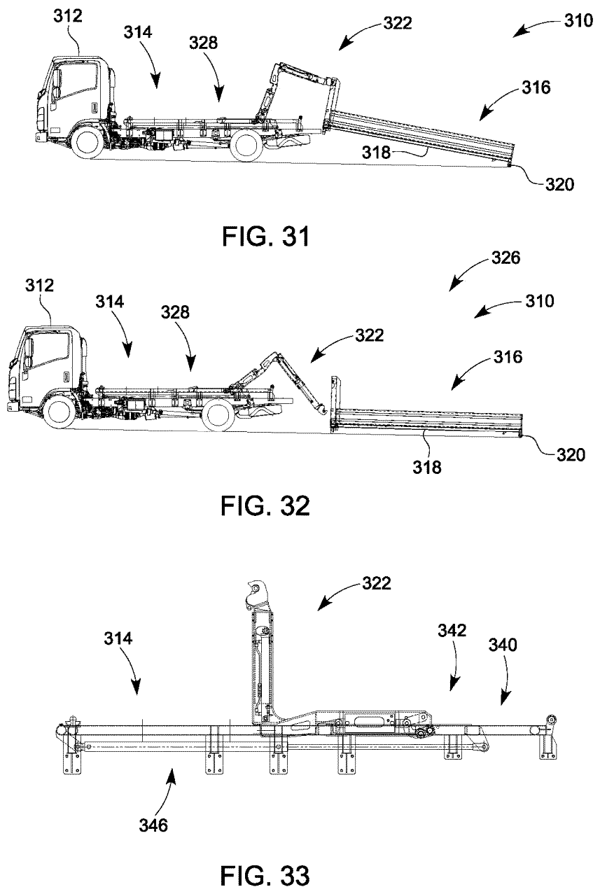

The self-loading assembly 310 includes a loading arm 322 operatively associated with the base frame 314. The loading arm 322 is operatively adapted to move relative to the base frame 314 between (i) a transport position 324, shown in FIG. 23, in which the cargo body 316 is located on/supported by the base frame 314, and (ii) an offload position 326, shown in FIG. 31, wherein the cargo body 316 is offloaded from the base frame 314.

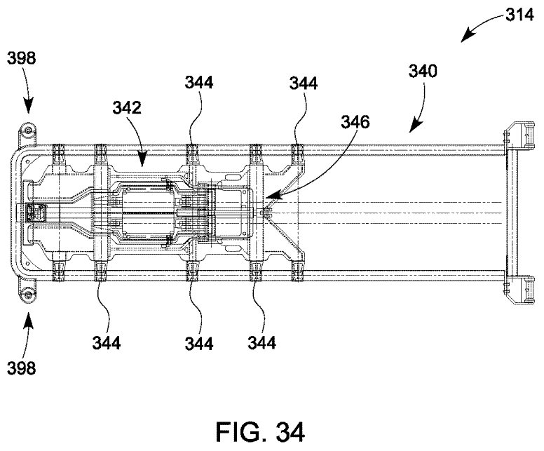

Referring also to FIGS. 33 and 34, the self-loading assembly 310 also includes an actuator assembly 328 operatively adapted to move the loading arm 322 between the transport position 324 and the offload position 326. The actuator assembly 328 operates on the same principles as the actuator assembly 228 wherein the actuator assembly 328 includes two actuators 334 located side-by-side so that the actuator assembly 328 includes (i) two non-illustrated arm pivot members on which the loading arm 322 is mounted and about which the loading arm 322 pivots as it moves between the transport position 324 and the offload position 326, and (ii) two linkage assemblies 332 respectively connecting the loading arm 322 with the two actuators 334. The linkage assemblies 332 are adapted to move the loading arm 322 between the transport position 324 and the offload position 326 when the actuators 334 are caused to move between a non-illustrated first and second positions. In this embodiment the actuators 334 are also each provided in the form of a 5″ bore×2″ rod×8″ stroke hydraulic ram powered by a non-illustrated power take-off (PTO). Also, as with the second embodiment self-loading assembly 210, the two actuators 334 enable the actuator assembly 328 to accommodate greater payload to be carried by the cargo body 316, as compared with the cargo body 16 of the utility vehicle 12, and which is to be offloaded by the self-loading assembly 310.

The third embodiment self-loading assembly 310 is adapted for use with a medium wheelbase vehicle 312. To ensure that the loading arm 322 is in a suitable position to offload the cargo body 316, the base frame 314 includes a frame body 340 and a subframe assembly 342 which is mounted to the frame body 340 via rollers 344. The rollers 344 enable the subframe assembly 342 to be moved along the frame body 340. Movement of the subframe assembly 342 is effected by a frame actuator 346, here a hydraulic cylinder, which is coupled to the subframe assembly 342. By extending and retracting the frame cylinder 346 the subframe assembly 342 is moved along the frame body 340 a distance of 1,370 mm.

The loading arm 322 and actuator assembly 328 are mounted to the subframe assembly 342. The subframe assembly 324 is adapted to be moved between a cab position 348 in which the loading arm is located proximate the cab 350 of the vehicle 312, shown in FIG. 23, and an intermediate position 352, shown FIG. 25, located between the cab 350 and the rear 354 of the vehicle. The loading arm 322 is caused to offload the cargo body 316 when the loading arm 322 is located in the intermediate position 352. In the intermediate position 352 the loading arm 322 is suitably sized for offloading the cargo body 316 without being impeded by the vehicle 312.

The base frame 314 includes two securement formations 398 operatively adapted to cooperate with corresponding non-illustrated formations on the underside of the cargo body 316 to assist in securing the cargo body 316 in position on the base frame 314. To move the subframe assembly 342 it is required that the securement formations 398 be retracted from the formations on the underside of the cargo body 316. This is achieved by moving the loading arm 322 through 5 degrees, shown in FIG. 24. The loading arm 322 can now be moved to the intermediate position 352 of FIG. 25. In the offload position of FIG. 31 the loading arm 322 has rotated through 142.09 degrees.

A non-illustrated hydraulic control system is employed for controlling movement of the frame actuator 236 to a desired position so as to locate the loading arm in the intermediate position 352.

Although the invention has been described with reference to specific examples, it will be appreciated by those skilled in the art that the invention may be embodied in many other forms.

### KEY TO REFERENCE NUMERALS IN DRAWINGS

10 Self-loading assembly
12 Utility vehicle
14 Base frame
16 Cargo body
18 Tray
20 Caster
22 Loading arm
24 Transport position
26 Offload position
28 Actuator assembly
30 Arm pivot member
32 Linkage assembly
34 Actuator
36 First position (actuator)
38 Second position (actuator)
40 Arm linkage member
42 Frame linkage member
44 Base end
46 Arm linkage member end
48 Frame pivot member
50 Recess
52 Linkage pivot member
54 Arm end
56 Actuator pivot member
57 Actuator end
58 Second frame linkage member
60 Actuator rod
62 Retracted position
64 Extended position
66 First loading arm member
68 Second loading arm member
70 Actuator space
72 Gripping assembly
74 Portion of cargo body
76 Gripping actuator
77 Gripping position
78 Locking member
80 Secondary actuator
82 Rest position
84 Active position
86 Support member
88 Cross support member
90 Cabin end
92 Rear end
94 Brace member
96 Roller
98 Securement formation
100 Proximity sensor
102 Proximity sensor
210 Second embodiment self-loading assembly
212 Short wheelbase commercial vehicle
214 Base frame
216 Cargo body
218 Flat tray
220 Casters
222 Loading arm
224 Transport position
226 Offload position
228 Actuator assembly
230 Arm pivot members
232 Linkage assembly
234 Actuators
310 Third embodiment self-loading assembly
312 Medium wheelbase commercial vehicle
314 Base frame
316 Cargo body
318 Flat tray
320 Casters
322 Loading arm
324 Transport position
326 Offload position
328 Actuator assembly
332 Linkage assembly
334 Actuators
340 Frame body
342 Subframe assembly
344 Rollers
346 Frame actuator
348 Cab position
350 Cab
352 Intermediate position
354 Rear of vehicle
398 Securement formation

1. A self-loading assembly for a vehicle, the self-loading assembly including:
a base frame operatively secured to the vehicle;
a cargo body operatively adapted to be located on the base frame to be transported by the vehicle;
a loading arm operatively associated with the base frame, the loading arm operatively adapted to move relative to the base frame between (i) a transport position in which the cargo body is located on to the base frame, and (ii) an offload position wherein the cargo body is offloaded from the base frame;
an actuator assembly operatively adapted to move the loading arm between the transport position and the offload position, the actuator assembly including (i) an arm pivot member on which the loading arm is mounted and about which the loading arm pivots as it moves between the transport position and the offload position, and (ii) a linkage assembly connecting the loading arm with an actuator, the linkage assembly adapted to move the loading arm between the transport position and the offload position when the actuator is caused to move between a first position and a second position.

2. A self-loading assembly according to claim 1, wherein the vehicle is a utility vehicle or a light commercial vehicle.

3. A self-loading assembly according to claim 2, wherein the linkage assembly includes an (i) arm linkage member coupled to the loading arm, and (ii) a frame linkage member coupled to the base frame at a base end and to the arm linkage member at an arm linkage member end.

4. A self-loading assembly according to claim 3, wherein the frame linkage member is pivotally mounted about a frame pivot member coupled to the base frame.

5. A self-loading assembly according to claim 4, wherein the frame linkage member defines a recess operatively adapted to receive the arm pivot member therein when the loading arm is located in the offload position.

6. A self-loading assembly according to claim 5, wherein the arm linkage member is (i) coupled to the loading arm via a linkage pivot member located at an arm end of the arm linkage member, and (ii) coupled to the actuator via an actuator pivot member at an actuator end of the arm linkage member.

7. A self-loading assembly according to claim 6, wherein the frame linkage member is a first frame linkage member and the linkage assembly includes a second frame linkage member opposing the first frame linkage member and laterally spaced apart from the first frame linkage member.

8. A self-loading assembly according to claim 7, wherein the actuator includes an actuator rod moveable between a retracted position and an extended position, wherein the actuator is moved from the first position to the second position as the actuator rod is moved from retracted position to the extended position.

9. A self-loading assembly according to claim 8, wherein the loading arm includes a first loading arm member and a transverse second loading arm member, the first loading arm member being mounted to the arm pivot member.

10. A self-loading assembly according to claim 9, wherein the first loading arm member defines an actuator space for holding the actuator when the loading arm is located in the transport position.

11. A self-loading assembly according to claim 10, wherein the second loading arm member includes a gripping assembly operatively adapted to grip a portion of the cargo body.

12. A self-loading assembly according to claim 11, wherein the gripping assembly includes a gripping actuator operatively adapted to locate the gripping assembly in (i) a gripping position for gripping the cargo body, and (ii) a release position to release the cargo body.

13. A self-loading assembly according to claim 12, wherein the second loading arm member includes a secondary actuator operatively adapted to move the second loading arm member between a rest position and an active position, movement of the second loading arm member to the active position causing the cargo body to be tilted.

14. A self-loading assembly according to claim 13, wherein the base frame includes a frame body and a subframe assembly to move relative to the frame body.

15. A self-loading assembly according to claim 14, wherein the base frame includes a frame actuator to effect movement of the subframe assembly.

16. A vehicle including a self-loading assembly according to claim 15.

17. A self-loading assembly according to claim 1, wherein the linkage assembly includes an (i) arm linkage member coupled to the loading arm, and (ii) a frame linkage member coupled to the base frame at a base end and to the arm linkage member at an arm linkage member end.

18. A self-loading assembly according to claim 1, wherein the base frame includes a frame body and a subframe assembly to move relative to the frame body.

19. A vehicle including a self-loading assembly according to claim 1.

20. A vehicle including a self-loading assembly according to claim 2.
